(19) United States
(12) Patent Application Publication
(10) Pub. No.: US 2013/0031516 A1
(43) Pub. Date: Jan. 31, 2013

(54) IMAGE PROCESSING APPARATUS HAVING TOUCH PANEL

(71) Applicants: Kazumi SAWAYANAGI, Itami-shi (JP); Toshihiko OTAKE, Ikeda-shi (JP); Hidetaka IWAI, Itami-shi (JP); Toshikazu KAWAGUCHI, Kobe-shi (JP); Masayuki KAWAMOTO, Amagasaki-shi (JP)

(72) Inventors: Kazumi SAWAYANAGI, Itami-shi (JP); Toshihiko OTAKE, Ikeda-shi (JP); Hidetaka IWAI, Itami-shi (JP); Toshikazu KAWAGUCHI, Kobe-shi (JP); Masayuki KAWAMOTO, Amagasaki-shi (JP)

(73) Assignee: Konica Minolta Business Technologies, Inc., Chiyoda-ku (JP)

(21) Appl. No.: 13/553,848

(22) Filed: Jul. 20, 2012

(30) Foreign Application Priority Data
Jul. 26, 2011 (JP) 2011-163145

(51) Int. Cl. G06F 3/041; G06F 3/048

(52) U.S. Cl. 715/863

(57) ABSTRACT

An image processing apparatus includes an operation panel as an example of a touch panel and a display device, as well as CPU as an example of a processing unit for performing processing based on a contact. CPU includes a first identifying unit for identifying a file to be processed, a second identifying unit for identifying an operation to be executed, a determination unit for determining whether or not the combination of the file and operation as identified is appropriate, and a display unit for displaying a determination result. In the case where one of the identifying units previously detects a corresponding gesture to identify the file or the operation, and when a gesture corresponding to the other identifying unit is detected next, then the determination result is displayed on the display device before identification of the file or the operation is completed by the gesture.

This application is based on Japanese Patent Application No. 2011-163145 filed with the Japan Patent Office on Jul. 26, 2011, the entire content of which is hereby incorporated by reference.

### BACKGROUND OF THE INVENTION

1. Field of the Invention

The present invention relates to an image processing apparatus, and more particularly relates to an image processing apparatus having a touch panel.

2. Description of the Related Art

In the field of portable telephone and music reproducer, an increasing number of apparatuses have a touch panel. There is an advantage in that, the use of a touch panel as an operation input device enables a user to make an operation input to an apparatus with an intuitive manipulation.

On the other hand, a misoperation may occur since the operation input is made by touching with a finger or the like a region such as a button displayed on the touch panel. Since the area of touch panel is limited particularly in small apparatuses such as a portable telephone, a region serving as an option is small and/or the spacing between adjacent regions presented as options is small, so that a misoperation is more likely to occur.

With respect to this problem, Japanese Laid-Open Patent Publication No. 2005-044026, for example, discloses a technique in which, when a touch operation across a plurality of regions is detected, a neighboring icon image is displayed under magnification, and a gesture on the icon image displayed under magnification is accepted again.

However, by the method disclosed in Japanese Laid-Open Patent Publication No. 2005-044026, a magnified image is displayed every time a touch operation across a plurality of regions is detected, and an operation is required again, resulting in a complicated operation, so that an operation input cannot be made with an intuitive manipulation.

### SUMMARY OF THE INVENTION

The present invention was made in view of such problems, and has an object to provide an image processing apparatus that enables an operation on a file to be executed with an intuitive manipulation while suppressing a misoperation.

To achieve the above-described object, according to an aspect of the present invention, an image processing apparatus includes a touch panel, a display device, and a processing unit for performing processing based on a contact on the touch panel. The processing unit includes a first identifying unit for detecting a first gesture using the touch panel, thereby identifying a file to be processed based on a contact in the first gesture, a second identifying unit for detecting a second gesture using the touch panel, thereby identifying an operation to be executed based on a contact in the second gesture, a determination unit for determining whether or not the combination of the file to be processed and the identified operation is appropriate, a display unit for displaying a determination result in the determination unit, on the display device, and an execution unit for executing the identified operation on the file to be processed. In the case where one of the first identifying unit and the second identifying unit previously detects one of the first gesture and the second gesture to identify one of the file and the operation, and when the other gesture is detected next, then the determination result is displayed on the display device before identification of one of the file and the operation is completed by detection of the other gesture.

Preferably, the first identifying unit and the second identifying unit decide one of the file and the operation based on the contact at the time of completion of one of the first gesture and the second gesture. The execution unit does not execute the identified operation on the file to be processed when it is determined in the determination unit that the combination of the file to be processed and the identified operation as decided is not appropriate, and executes the identified operation on the file to be processed when it is determined that the combination as decided is appropriate.

Preferably, the determination unit has previously stored therein information about a target of each operation executable in the image processing apparatus.

Preferably, the other gesture is the second gesture. The second identifying unit identifies the operation at least based on the contact at the time of start of the second gesture when the start of the second gesture is detected, and identifies the operation at least based on the contact at the time of start of the second gesture and the contact at the time of completion of the second gesture when the completion is detected. For the file to be processed identified by the first identifying unit, the determination unit determines whether or not each of the operation identified by the second identifying unit at least based on the contact at the time of start of the second gesture and the operation identified by the second identifying unit at least based on the contact at the time of start of the second gesture and the contact at the time of the completion is appropriate.

Preferably, the other gesture is the first gesture. The first identifying unit identifies the file to be processed at least based on the contact at the time of start of the first gesture when the start of the first gesture is detected, and identifies the file to be processed at least based on the contact at the time of start of the first gesture and the contact at the time of completion of the first gesture when the completion is detected. The determination unit determines whether or not the operation identified by the second identifying unit is appropriate for each of the file to be processed identified by the first identifying unit at least based on the contact at the time of start of the first gesture and the file to be processed identified by the first identifying unit at least based on the contact at the time of start of the first gesture and the contact at the time of the completion.

Preferably, the image processing apparatus further includes a communications unit for communicating with an other device, and an acquisition unit for acquiring information that identifies one of a file to be processed and an operation identified in the other device by a gesture using a touch panel of the other device, in place of one of the first identifying unit and the second identifying unit.

Preferably, the first gesture is a gesture of, continuously after two contacts are made on the touch panel, moving the two contacts in a direction that a spacing therebetween is decreased and then releasing the two contacts after being moved, and the second gesture is a gesture of, continuously after two contacts are made on the touch panel, moving the two contacts in a direction that the spacing therebetween is increased and then releasing the two contacts after being moved.

According to another aspect of the present invention, a method of controlling is a method of controlling an image processing apparatus for causing the image processing apparatus having a touch panel to execute an operation on a file. The method includes the steps of detecting a first gesture using the touch panel, thereby identifying a file to be processed based on a contact in the first gesture, detecting a second gesture using the touch panel, thereby identifying an operation to be executed based on a contact in the second gesture, determining whether or not the combination of the file to be processed and the identified operation is appropriate, displaying a determination result of the determining step on a display device, and executing the identified operation on the file to be processed when it is determined that the combination of the file to be processed and the identified operation is appropriate. In the case where one of the step of identifying a file and the step of identifying an operation previously detects one of the first gesture and the second gesture to identify one of the file and the operation, and when the other gesture is detected next, then the determination result is displayed on the display device before identification of one of the file and the operation is completed by detection of the other gesture.

According to still another aspect of the present invention, a non-transitory computer-readable storage medium is a non-transitory computer-readable storage medium having stored therein a program for causing an image processing apparatus having a touch panel and a controller connected to the touch panel to execute an operation on a file. The program instructs the controller to perform the steps of detecting a first gesture using the touch panel, thereby identifying a file to be processed based on a contact in the first gesture, detecting a second gesture using the touch panel, thereby identifying an operation to be executed based on a contact in the second gesture, determining whether or not the combination of the file to be processed and the identified operation is appropriate, displaying a determination result of the determining step on a display device, and executing the identified operation on the file to be processed when it is determined that the combination of the file to be processed and the identified operation is appropriate. In the case where one of the step of identifying a file and the step of identifying an operation previously detects one of the first gesture and the second gesture to identify one of the file and the operation, and when the other gesture is detected next, then the program causes the determination result to be displayed on the display device before identification of one of the file and the operation is completed by detection of the other gesture.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a specific example of a configuration of an image processing system according to an embodiment.

FIG. 2 shows a specific example of a hardware configuration of MFP (Multi-Functional Peripheral) included in the image processing system.

FIG. 3 shows a specific example of a hardware configuration of a portable terminal included in the image processing system.

FIG. 4 shows a specific example of a hardware configuration of a server included in the image processing system.

FIG. 5 shows a specific example of a function list screen displayed on an operation panel of MFP.

FIG. 6 illustrates a pinch-in gesture.

FIG. 7 illustrates a pinch-out gesture.

FIGS. 8 and 9 each show a specific example of a display screen on the operation panel of MFP.

FIG. 10 is a block diagram showing a specific example of a functional configuration of MFP according to a first embodiment.

FIGS. 11 to 15 each illustrate a specific example of a method of identifying an icon indicated by the pinch-in gesture.

FIG. 16 is a flow chart showing a specific example of an operation in MFP.

FIGS. 17 and 18 each show a specific example of the display screen on the operation panel of MFP according to a variation.

FIG. 19 shows the flow of operation in an image processing system according to a second embodiment.

FIG. 20 is a block diagram showing a specific example of a functional configuration of a portable terminal according to the second embodiment.

FIG. 21 is a block diagram showing a specific example of a functional configuration of a server according to the second embodiment.

FIG. 22 is a block diagram showing a specific example of a functional configuration of MFP according to the second embodiment.

FIG. 23 shows a specific example of a display screen on an operation panel of MFP according to a variation 1.

FIG. 24 shows a specific example of a display screen on an operation panel of MFP according to a variation 2.

### DESCRIPTION OF THE PREFERRED EMBODIMENTS

Hereinafter, embodiments of the present invention will be described with reference to the drawings. In the following description, like parts and components are denoted by like reference characters. They are named and function identically as well.

<System Configuration>

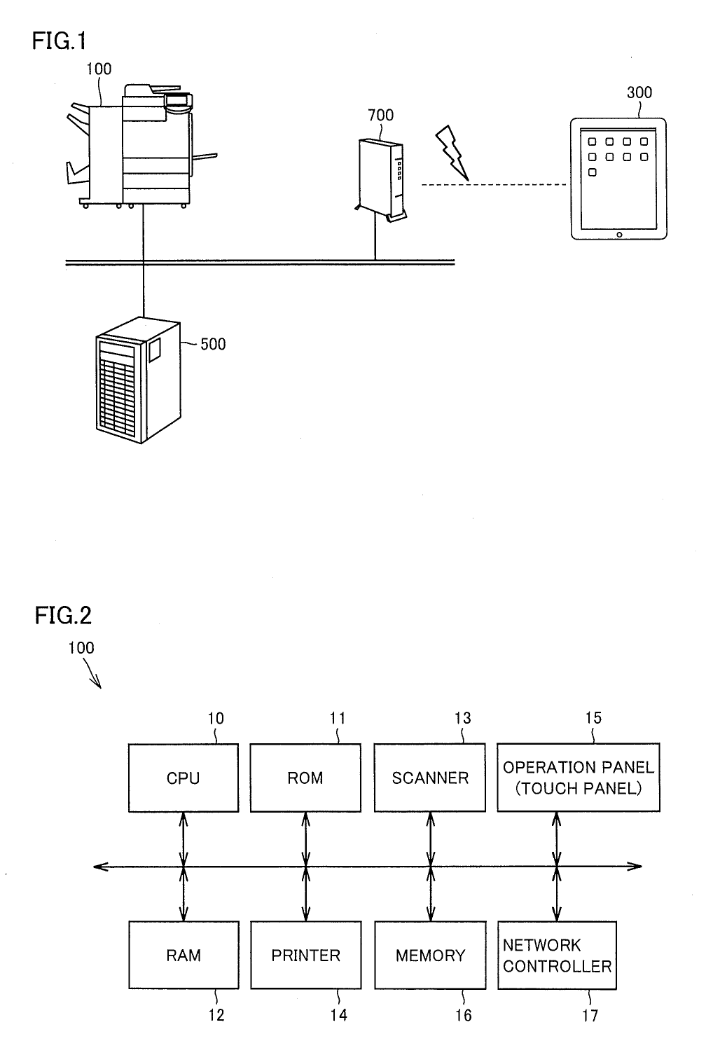

FIG. 1 shows a specific example of a configuration of an image processing system according to the present embodiment.

Referring to FIG. 1, the image processing system according to the present embodiment includes an MFP 100 as an example of an image processing apparatus, a portable terminal 300 as a terminal device, and a server 500. They are connected through a network, such as LAN (Local Area Network).

The network may be wired or may be wireless. As an example, as shown in FIG. 1, MFP 100 and server 500 are connected to a wired LAN, the wired LAN further including a wireless LAN access point 700, and portable terminal 300 is connected to wireless LAN access point 700 through the wireless LAN.

The image processing apparatus is not limited to MFP, but may be any kind of image processing apparatus that has a touch panel as a structure for accepting an operation input. Other examples may include a copying machine, a printer, a facsimile machine, and the like.

Portable terminal 300 may be any device that has a touch panel as a structure for accepting an operation input. For example, it may be a portable telephone with a touch panel, a personal computer, PDA (Personal Digital Assistants), a music reproducer, or an image processing apparatus such as MFP.

<Configuration of MFP>

FIG. 2 shows a specific example of a hardware configuration of MFP 100.

Referring to FIG. 2, MFP 100 includes a CPU (Central Processing Unit) 10 as an arithmetic device for overall control, a ROM (Read Only Memory) 11 for storing programs and the like to be executed by CPU 10, a RAM (Random Access Memory) 12 for functioning as a working area during execution of a program by CPU 10, a scanner 13 for optically reading a document placed on a document table not shown to obtain image data, a printer 14 for fixing image data on a printing paper, an operation panel 15 including a touch panel for displaying information and receiving an operation input to MFP 100 concerned, a memory 16 for storing image data as a file, and a network controller 17 for controlling communications through the above-described network.

Operation panel 15 includes the touch panel and an operation key group not shown. The touch panel is composed of a display device such as a liquid crystal display and a pointing device such as an optical touch panel or a capacitance touch panel, the display device and the pointing device overlapping each other, and displays an operation screen so that an indicated position on the operation screen is identified. CPU 10 causes the touch panel to display the operation screen based on data stored previously for causing screen display.

The indicated position (position of touch) on the touch panel as identified and an operation signal indicating a pressed key are input to CPU 10. CPU 10 identifies details of manipulation based on the pressed key or the operation screen being displayed and the indicated position, and executes a process based thereon.

<Configuration of Portable Terminal>

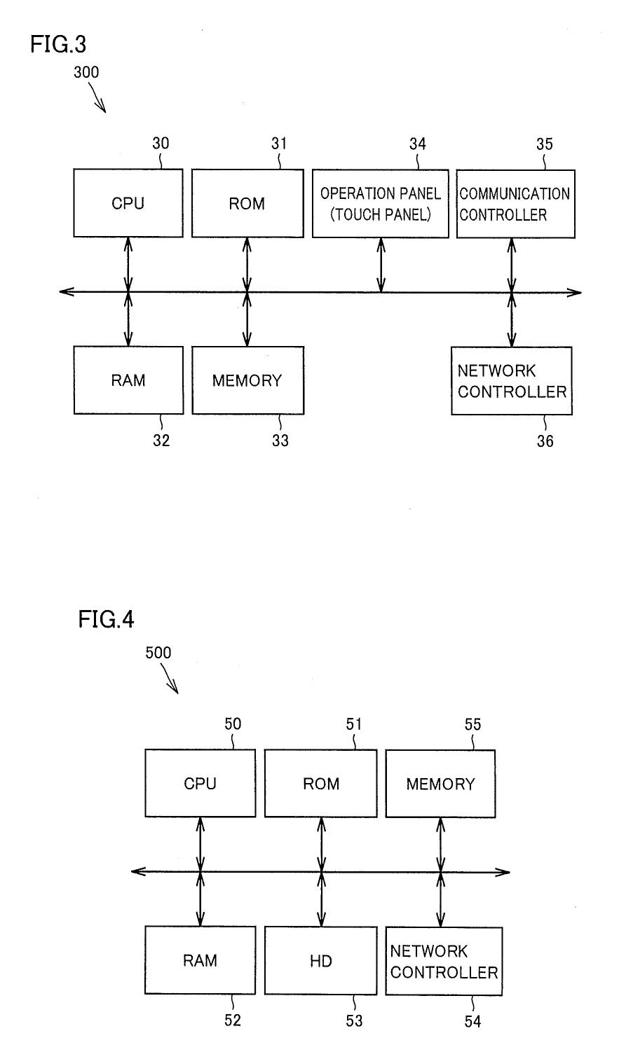

FIG. 3 shows a specific example of a hardware configuration of portable terminal 300.

Referring to FIG. 3, portable terminal 300 includes a CPU 30 as an arithmetic device for overall control, a ROM 31 for storing programs and the like to be executed by CPU 30, a RAM 32 for functioning as a working area during execution of a program by CPU 30, a memory 33 for storing image data as a file or storing another type of information, an operation panel 34 including a touch panel for displaying information and receiving an operation input to portable terminal 300 concerned, a communication controller 35 for controlling communications with a base station not shown, and a network controller 36 for controlling communications through the above-described network.

Operation panel 34 may have a configuration similar to that of operation panel 15 of MFP 100. That is, as an example, operation panel 34 includes a touch panel composed of a display device such as a liquid crystal display and a pointing device such as an optical touch panel or a capacitance touch panel, the display device and the pointing device overlapping each other.

CPU 30 causes the touch panel to display an operation screen based on data stored previously for causing screen display. On the touch panel, the indicated position on the operation screen is identified, and an operation signal indicating that position is input to CPU 30. CPU 30 identifies details of manipulation based on the operation screen being displayed and the indicated position, and executes a process based thereon.

<Configuration of Server>

FIG. 4 shows a specific example of a hardware configuration of server 500.

Referring to FIG. 4, server 500 is implemented by a typical computer or the like as described above, and as an example, includes a CPU 50 as an arithmetic device for overall control, a ROM 51 for storing programs and the like to be executed by CPU 50, a RAM 52 for functioning as a working area during execution of a program by CPU 50, a HD (Hard Disk) 53 for storing files and the like, and a network controller 54 for controlling communications through the above-described network.

### FIRST EMBODIMENT

<Outline of Operation>

In the image processing system according to the first embodiment, MFP 100, in accordance with a gesture on operation panel 15, accesses a file stored in a predetermined area of memory 16, which is a so-called box associated with the user or a user group, or an external memory not shown, and performs processing such as printing on a file read from the external memory.

At this time, the user performs a “pinch-in” gesture on operation panel 15 on an icon presenting a target file or an icon showing a storage location where that file is stored, thereby indicating that file as a file to be processed.

MFP 100 accepts this gesture to identify the target file, and stores the file as a file to be processed in a temporary storage area previously defined.

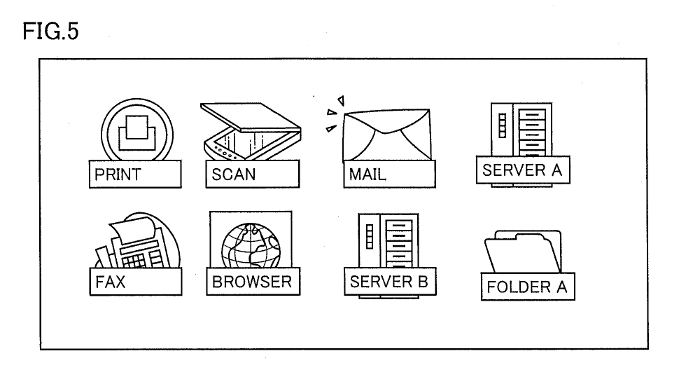

The user causes the display of operation panel 15 to transition to a function list screen. FIG. 5 shows a specific example of the function list screen displayed on operation panel 15 of MFP 100. This screen shows an example where, as icons showing executable processing in MFP 100, an icon for executing a printing operation, an icon for executing a scan operation, an icon for executing an operation of transmitting image data by e-mail, an icon for executing an operation of transmitting image data to a server for storage therein, an icon for executing an operation of transmitting image data by facsimile, an icon for starting a browser application for displaying a website, and an icon for executing an operation of storing image data in a folder which is a predetermined area of memory 16.

Among these icons, the user performs a “pinch-out” gesture on an icon showing an operation to be executed, such as, for example, the “print icon”, thereby indicating processing to be executed on the indicated file.

It is noted that, in the following description, a file to be processed and an operation to be executed shall be indicated by “pinch-in” and “pinch-out” gestures.

However, this manipulation for indication is not necessarily limited to the “pinch-in” and “pinch-out” gestures. It may be other gestures as long as at least one of these gestures is a manipulation started with touching the operation panel which is a touch panel and including a predetermined continuous movement, that is, a series of gestures started with touching. Herein, the “continuous movement” includes a motion to move a contact from its initial position while keeping the touch condition, and a motion including a plurality of touches with the touch condition released. The former motion includes the “pinch-in” gesture, the “pinch-out” gesture, a “trace” gesture, and the like which will be described later, and the latter motion includes a plurality of tap gestures and the like.

The above-described pinch-in and pinch-out gestures will now be described.

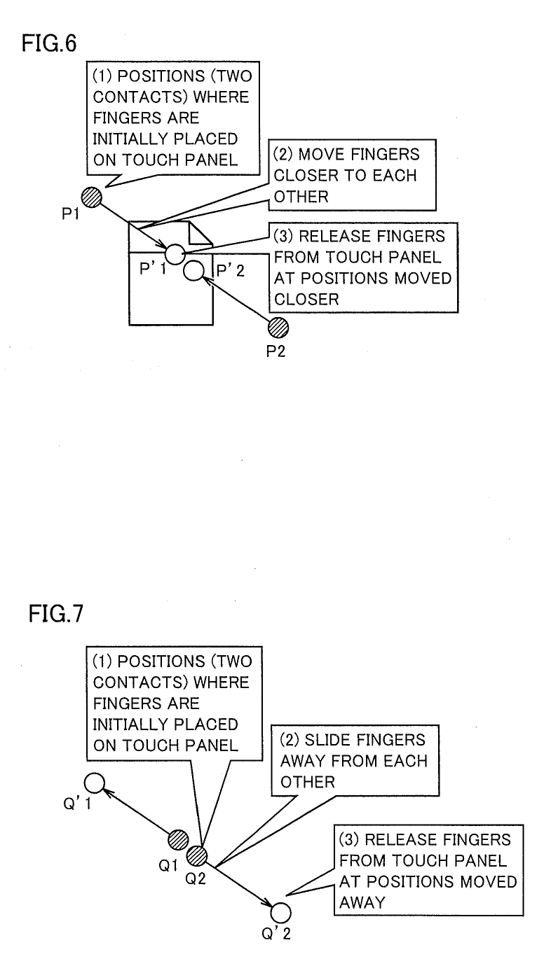

FIG. 6 illustrates a “pinch-in” gesture. Referring to FIG. 6, the “pinch-in” or pinching gesture refers to a motion of making two contacts P1 and P2 on an operation panel using, for example, two fingers or the like, and then moving the fingers closer to each other from their initial positions linearly or substantially linearly, and releasing the two fingers from the operation panel at two contacts P′1 and P′2 moved closer.

When it is detected that two contacts P1 and P2 on the operation panel have been made simultaneously, and further, the respective contacts have been continuously displaced from their initial positions linearly or substantially linearly, and both the contacts have been released almost simultaneously at two contacts P′1 and P′2 positioned at a spacing narrower than the spacing between their initial positions, CPU detects that the “pinch-in” gesture has been performed.

FIG. 7 illustrates a “pinch-out” gesture. Referring to FIG. 7, the “pinch-out” or anti-pinching gesture refers to a motion of making two contacts Q1 and Q2 on an operation panel using, for example, two fingers or the like, and then moving the fingers away from their initial positions linearly or substantially linearly, and releasing the two fingers from the operation panel at two contacts Q′1 and Q′2 moved away to some degree.

When it is detected that two contacts Q1 and Q2 on the operation panel have been made simultaneously, and further, the respective contacts have been continuously displaced from their initial positions linearly or substantially linearly, and both the contacts have been released almost simultaneously at two contacts Q′1 and Q′2 positioned at a spacing wider than the spacing between their initial positions, CPU detects that the “pinch-out” or de-pinching gesture has been performed.

Specific details of the “pinch-in” and “pinch-out” gestures shall be similar in other embodiments which will be described later.

MFP 100 accepts the pinch-out gesture on operation panel 15 to identify an operation targeted for the pinch-out gesture. When the identified processing is executable on the file held as the file to be processed, the processing is executed on the held file.

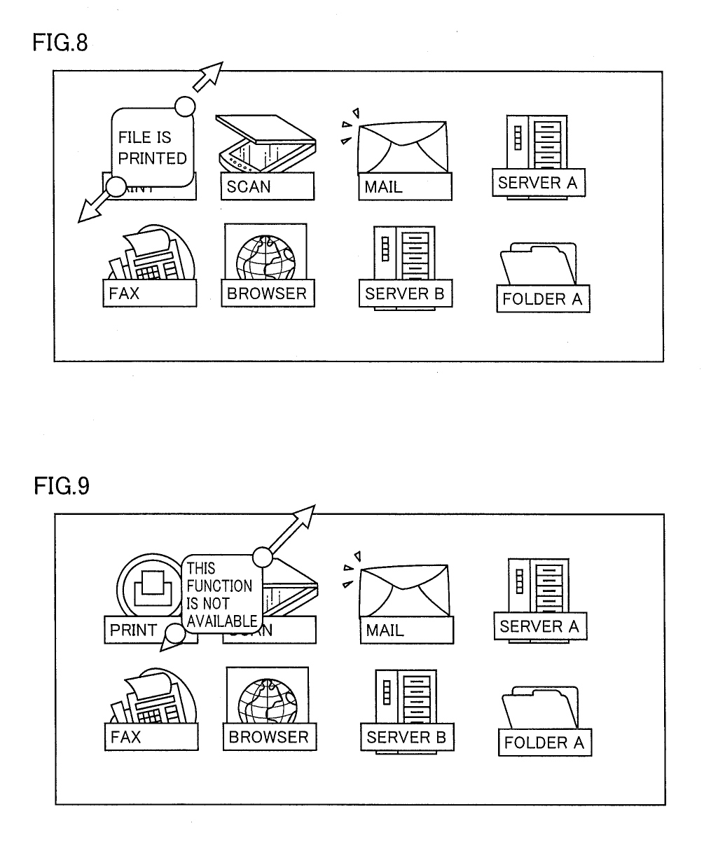

At this time, as shown in FIG. 8, information that reports image processing to be executed is displayed on operation panel 15 of MFP 100. FIG. 8 shows an example where the “print icon” is identified as having been indicated by a pinch-out gesture, and a pop-up describing “FILE IS PRINTED” is displayed in proximity to the indicated icon. Of course, that the operation is executable, the details of operation to be executed and the like may be reported by another method. For example, it is not limited to display, but may be sound, lamp lighting or the like.

On the other hand, when the operation identified as the target for pinch-out gesture is not suitable for processing on the indicated file, MFP 100 does not execute processing on that file.

At this time, as shown in FIG. 9, a warning that the indicated operation is unexecutable is displayed on operation panel 15 of MFP 100. FIG. 9 shows an example where the “scan icon” adjacent to the “print icon” is identified as having been indicated by a pinch-out gesture, and a pop-up describing that “THIS FUNCTION IS NOT AVAILABLE” is displayed in proximity to the indicated icon. Of course, in this case, that the operation is unexecutable, the details of indicated operation and the like may be reported by another method. In this case as well, it is not limited to display, but may be sound, lamp lighting or the like.

<Functional Configuration>

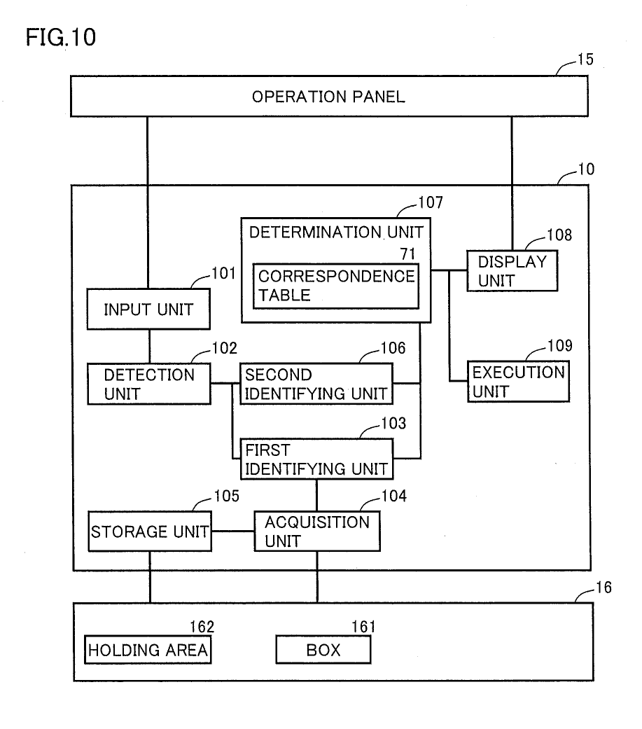

FIG. 10 is a block diagram showing a specific example of a functional configuration of MFP 100 according to the first embodiment for executing the above-described operation. Each function shown in FIG. 10 is a function mainly configured in CPU 10 by CPU 10 reading a program stored in ROM 11 and executing the program on RAM 12. However, at least some functions may be configured by the hardware configuration shown in FIG. 2.

Referring to FIG. 10, memory 16 includes box 161 which is the above-described storage area and a holding area 162 for temporarily holding an indicated file.

Further, referring to FIG. 10, CPU 10 includes an input unit 101 for receiving input of an operation signal indicating an instruction on operation panel 15, a detection unit 102 for detecting the above-described pinch-in gesture and/or pinch-out gesture based on the operation signal, a first identifying unit 103 for identifying a file presented by an icon indicated by the pinch-in gesture based on the indicated position presented by the operation signal, an acquisition unit 104 for reading and acquiring the identified file from box 161, a storage unit 105 for storing that file in holding area 162 of memory 16, a second identifying unit 106 for identifying an operation presented by an icon indicated by the pinch-out gesture based on an indicated position presented by the operation signal, a determination unit 107 for determining whether or not the operation is an operation that can process an indicated file, a display unit 108 for making a display on operation panel 15 in accordance with the determination, and an execution unit 109 for executing the identified operation on the indicated file when it is a processable operation.

It is noted that, in this example, a file to be processed shall be indicated from among files stored in box 161. Therefore, acquisition unit 104 shall access box 161 to acquire an indicated file from box 161. However, as described above, indication may be performed from among files stored in an external memory not shown or files stored in another device such as portable terminal 300. In that case, acquisition unit 104 may have a function of accessing another storage medium or device through network controller 17 to acquire a file.

First identifying unit 103 identifies an icon, displayed in an area defined based on at least either two contacts (two contacts P1, P2 in FIG. 6) indicated initially in the pinch-in gesture or two contacts (two contacts P′1, P′2 in FIG. 6) indicated finally, as an icon indicated by the pinch-in gesture.

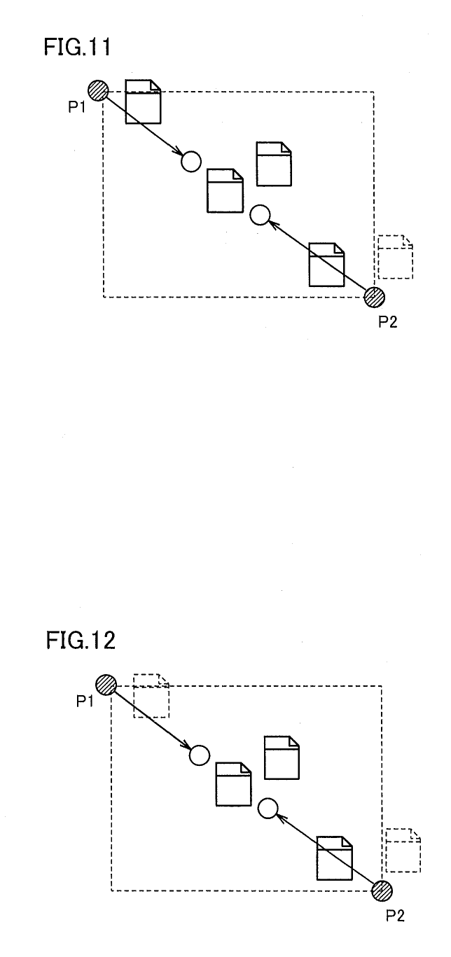

The method of identifying an icon indicated by the pinch-in gesture in first identifying unit 103 is not limited to a certain method. FIGS. 11 to 15 each illustrate a specific example of a method of identifying an icon indicated by the pinch-in gesture in first identifying unit 103.

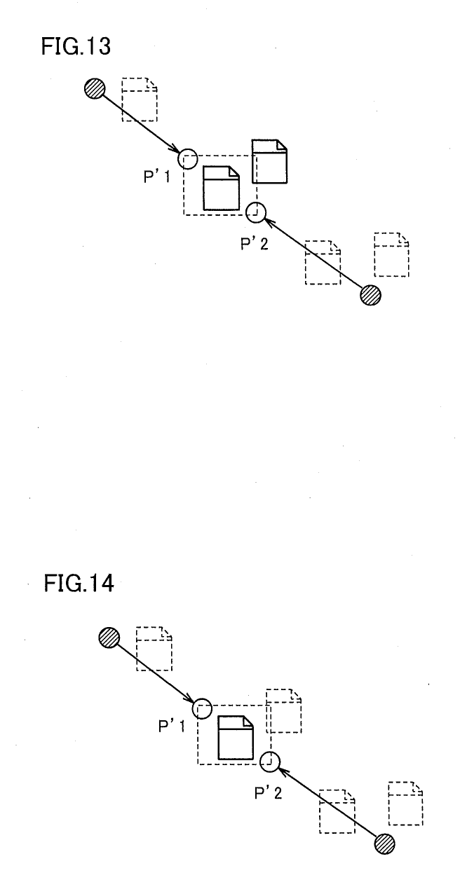

As an example, as shown in FIG. 11, first identifying unit 103 may identify a rectangle in which two contacts P1 and P2 indicated initially are at opposite corners as an area defined by the pinch-in gesture, and may identify icons, each of which is at least partially included in that rectangle, as indicated icons. Alternatively, as shown in FIG. 12, a rectangle in which two contacts P1 and P2 indicated initially are at opposite corners may be identified as an area defined by the pinch-in gesture, and icons completely included in that rectangle may be identified as indicated icons. With such identification, the user can indicate an intended file in an intuitive manner by touching operation panel 15 with two fingers so as to sandwich the intended icon, and performing a motion for the pinch-in gesture from that state. Even when an icon image is small, it can be indicated correctly.

As another example, as shown in FIG. 13, first identifying unit 103 may identify a rectangle in which two contacts P′1 and P′2 indicated finally are at opposite corners as an area defined by the pinch-in gesture, and may identify icons, each of which is at least partially included in that rectangle, as indicated icons. Alternatively, as shown in FIG. 14, a rectangle in which two contacts P′1 and P′2 indicated finally are at opposite corners may be identified as an area defined by the pinch-in gesture, and an icon completely included in that rectangle may be identified as an indicated icon. With such identification, the user can indicate an intended file in an intuitive manner by touching operation panel 15 with two fingers spaced apart, and then moving them closer to each other so as to sandwich the intended icon finally between the two fingers. Even when an icon image is small, it can be indicated correctly.

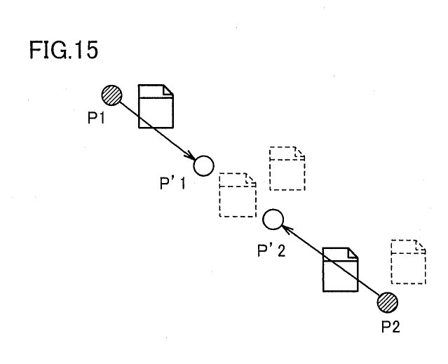

As still another example, as shown in FIG. 15, first identifying unit 103 may identify two lines that connect two contacts P1, P2 indicated initially and two contacts P′1, P′2 indicated finally, respectively, as areas defined by the pinch-in gesture, and may identify icons where either one line overlaps as indicated icons. With such identification, the user can indicate an intended file in an intuitive manner by moving the two fingers so as to pinch in the intended icon. Even when an icon image is small, it can be indicated correctly.

Holding area 162 of memory 16 temporarily stores the file identified by the pinch-in gesture. This “temporary” period is previously set at 24 hours, for example, and when there is no image processing executed on that file after the lapse of that period, CPU 10 may delete the file from the predetermined area of memory 16.

Further, when there is no image processing executed on that file within the above-described temporary period, CPU 10 may cause operation panel 15 to display a warning that image processing has not been executed on the indicated file, instead of or in addition to deletion of the file from the predetermined area of memory 16.

Second identifying unit 106 also identifies an icon indicated by the pinch-out gesture similarly to the methods described with reference to FIGS. 11 to 15, although the direction of finger movement is opposite (the fingers are moved away from each other).

It is noted that, when identifying the icon indicated by any of the methods shown in FIGS. 11 to 15, second identifying unit 106 accepts two contacts (two contacts Q1, Q2 in FIG. 7) on operation panel 15, and at the time when the contacts are moved continuously, identifies in real time the icon indicated by the pinch-out gesture based on the area defined by initial two contacts Q1, Q2 and two contacts having been moved. That is, second identifying unit 106 identifies in real time the icon at defined time intervals based on the area defined by initial two contacts Q1, Q2 and two contacts having been moved until the two contacts on operation panel 15 are released after the movement. Therefore, the identified icon may be changed during a single pinch-out gesture.

At this time, an icon is identified at least using initial two contacts Q1, Q2. As an example, an icon closest to the middle point of initial two contacts Q1, Q2 may be identified as an indicated icon. As another example, an icon closest to either of the contacts may be identified as an indicated icon.

Further, second identifying unit 106 also detects termination of the pinch-out gesture by detecting release of contacts after the movement, and identifies an icon finally indicated using the contacts (two contacts Q1′, Q2′ in FIG. 7) at the time of termination.

Every time information that identifies an operation targeted for the pinch-in gesture is input from second identifying unit 106, determination unit 107 determines whether or not that operation is suitable as the operation to be executed on the indicated file.

Determination unit 107 has a correspondence table 71 stored therein in order to determine whether or not the identified operation is suitable for the indicated file. Correspondence table 71 has defined therein information about a target for each operation. For example, files, text files and the like are defined for the print operation, the facsimile transmission operation and the like, and it is defined that there is no information to be a target for the scan operation, the browser start operation and the like.

For example, when the print operation is identified, since correspondence table 71 has files, text files and the like defined therein for the print operation, it is determined that the indicated file is included and that the operation is suitable for that file.

On the other hand, when the scan operation is identified, since information to be a target for the scan operation is not defined in correspondence table 71, it is determined that the indicated file is not present and that the operation is not suitable for that file.

Determination unit 107 inputs a determination result to display unit 108 every time a determination is made. Display unit 108 performs a display as shown in FIG. 8 or 9 in accordance with the determination result. At this time, preferably, pop-up is displayed in an area having two contacts made in the pinch-out gesture at opposite corners. Therefore, the pop-up display becomes gradually larger along with the pinch-out gesture.

As described above, since second identifying unit 106 identifies in real time the icon indicated by the pinch-out gesture along with the pinch-out gesture, the operation identified may be changed during the pinch-out gesture. Therefore, a report screen (pop-up display) provided by display unit 108 may be changed along with the pinch-out gesture.

In addition, as described above, since second identifying unit 106 identifies in real time the icon indicated by the pinch-out gesture along with the pinch-out gesture, the operation identified may be changed during the pinch-out gesture. Therefore, when the determination result in the operation finally identified using the contacts (two contacts Q1′, Q2′ in FIG. 7) at the time of termination of the pinch-out gesture is that the identified operation is suitable for processing on the indicated file, determination unit 107 instructs execution unit 109 to execute that operation.

<Flow of Operation>

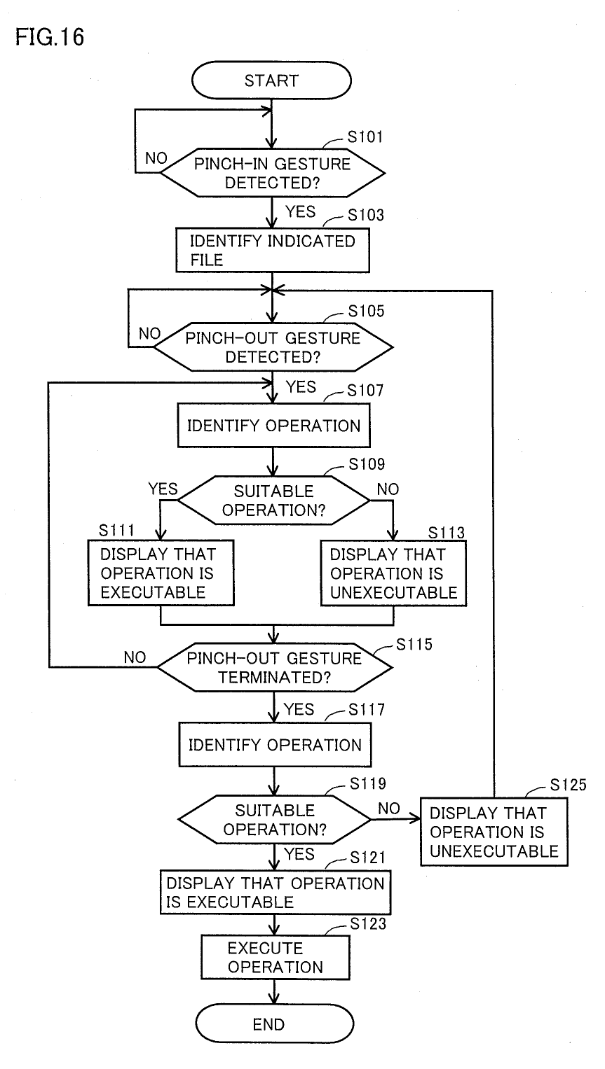

FIG. 16 is a flow chart showing a specific example of operations in MFP 100. The operations shown in the flow chart of FIG. 16 are implemented by CPU 10 reading a program stored in ROM 11 and executing the program on RAM 12 so as to cause the respective functions of FIG. 10 to be exerted.

Referring to FIG. 16, when it is detected that a pinch-in gesture has been performed with the file list screen being displayed on operation panel 15 (YES in Step S101), CPU 10 in Step S103 identifies an icon targeted for the pinch-in gesture, thereby identifying the indicated file. That file is temporarily held in holding area 162 of memory 16 as a file to be processed.

When it is detected that a pinch-out gesture has been started with the function list screen being displayed on operation panel 15 (YES in Step S105), CPU 10 in Step S107 identifies an icon targeted for the pinch-out gesture based on the contacts at the time of start of the pinch-out gesture and the contacts at the time of determination, thereby identifying the indicated operation.

It is noted that, when the pinch-out gesture is detected while the file is held in holding area 162 of memory 16, CPU 10 may advance the process to Step S107 described above to identify the indicated operation.

CPU 10 determines whether or not the operation identified in S107 described above is suitable for execution on the file indicated in step S103 described above. As a result, when it is determined as a suitable operation (YES in Step S109), CPU 10 in Step S111 performs a screen display as shown in FIG. 8, for example, to report that the operation is executable. When it is not a suitable operation (NO in Step S109), CPU 10 in Step S113 performs a screen display as shown in FIG. 9, for example, to issue a warning that the indicated operation is unexecutable.

CPU 10 repeats Steps S107 to S113 described above at previously defined intervals until termination of the pinch-out gesture is detected. Whether the operation indicated along with the pinch-out gesture is suitable or not will thereby be displayed on operation panel 15.

When termination of the pinch-out gesture is detected (YES in Step S115), CPU 10 in Step S117 identifies an operation based on the contacts at the time of termination of the pinch-out gesture, and finally determines whether or not that operation is suitable for execution on the indicated file.

As a result, when it is a suitable operation (YES in Step S119), CPU 10 in Step S121 performs a screen display as shown in FIG. 8, for example, to report that the operation is executable, and in Step S123 executes the identified operation on the indicated file. At this time, a button or the like for selecting between whether or not the operation is executable may be displayed on operation panel 15, and the operation may be executed upon receipt of a final instruction input.

When it is not a suitable operation (NO in Step S119), CPU 10 in Step S125 performs a screen display as shown in FIG. 9, for example, to report that the indicated operation is unexecutable, and then returns the process to Step S105 described above to wait until a pinch-out gesture is detected again.

<Effects of First Embodiment>

With such an operation performed in MFP 100 according to the first embodiment, it is possible to prevent an operation not intended by the user from being executed.

Particularly when icons are displayed on the operation panel of MFP or the like whose display region is restricted, each icon has a small area and/or the spacing between icons is narrow, so that an icon not intended by a pinch-out gesture, such as an icon adjacent to an intended icon, may be selected. Even in such a case, an operation will not be executed if it is an operation not suitable for execution on an indicated file, which can prevent a misoperation.

In addition, since it is displayed in MFP 100 whether or not the operation is suitable along with a pinch-out gesture, it is possible to make an appropriate icon be indicated, such as by adjusting the direction of the pinch-out gesture during the pinch-out gesture. The need to perform a gesture again can thus be eliminated, which can improve operability.

<Variations>

It is noted that, in the above examples, a target file shall be indicated by a pinch-in gesture, and then an operation to be executed shall be indicated by a pinch-out gesture. However, the order of indication is not limited to this order, but may be opposite. That is, an operation may be indicated first, and then a file may be indicated. In that case, the pinch-in gesture and the pinch-out gesture may be opposite to the above examples. The same applies to other embodiments which will be described later.

Furthermore, in the above examples, when the indicated operation is executable, it shall be displayed as shown in FIG. 8. As described above, since the pinch-out gesture for indicating an operation to be executed is performed with a timing different from the timing of indicating a target file by the pinch-in gesture, the file indicated as a target is not displayed when the pinch-out gesture is performed.

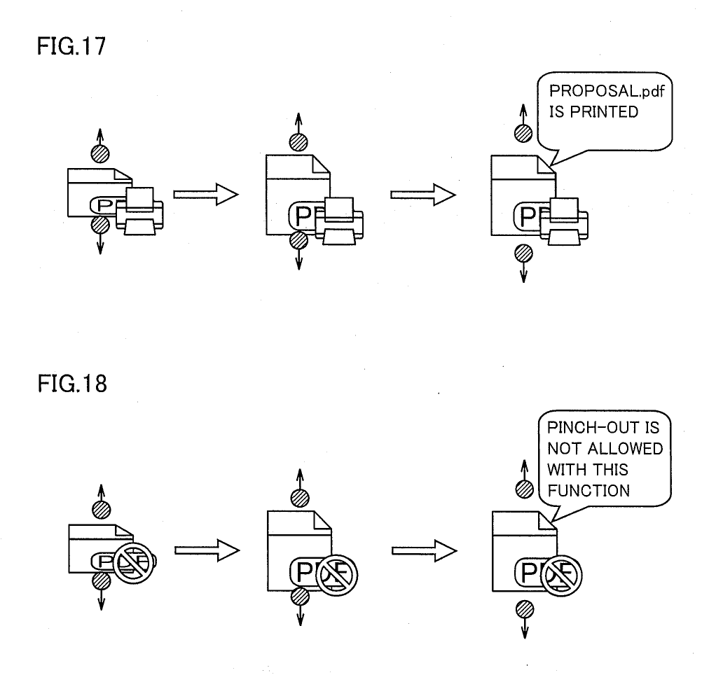

Therefore, MFP 100 according to a variation may cause information presenting a file indicated by the preceding pinch-in gesture to be displayed in proximity to an icon indicated by a pinch-out gesture, as shown in FIG. 17. In the example of FIG. 17, in association with the pinch-out gesture for indicating the “print icon”, an icon (a PDF icon in the example of FIG. 17) presenting the file indicated by the preceding pinch-in gesture is displayed between the two contacts. Preferably, CPU 10 causes that icon to be displayed while being changed in size along with the movement of contacts in the pinch-out gesture.

When it is determined that the identified operation is not suitable for execution on the indicated file, MFP 100 according to a variation also causes the icon (a PDF icon in the example of FIG. 18) presenting the file indicated by the preceding pinch-in gesture to be displayed, and further causes a warning that the operation is unexecutable to be displayed, as shown in FIG. 18. Preferably, at this time, the icon presenting the file indicated by the pinch-in gesture is displayed with a display that the operation is unexecutable (a prohibition mark in the example of FIG. 18) being added, as shown in FIG. 18.

In this way, the file indicated by the preceding pinch-in gesture can be checked at the time of pinch-out gesture, so that user operability can be increased more.

### SECOND EMBODIMENT

<Outline of Operation>

In the first embodiment, both a target file and an operation to be executed on that file shall be indicated in MFP 100, however, they may be indicated by different devices, and information thereof may be transmitted to MFP 100.

As an example, in an image processing system according to the second embodiment, a file to be processed is identified by a pinch-in gesture on operation panel 34 of portable terminal 300, and processing to be executed is indicated by a pinch-out gesture on operation panel 15 of MFP 100.

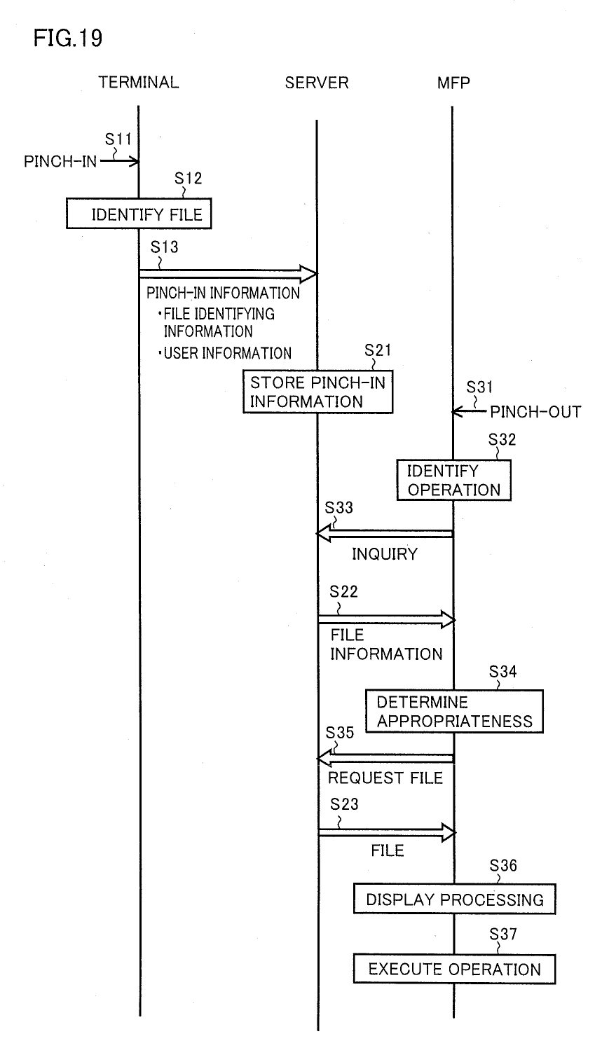

FIG. 19 shows the flow of operation in the image processing system according to the second embodiment.

Referring to FIG. 19, when a pinch-in gesture is performed with a screen displaying a file list being displayed on operation panel 34 of portable terminal 300 (Step S11), a file indicated in portable terminal 300 is identified in Step S12, and information at least including information that identifies that file is transmitted to server 500 in Step S13. In the following description, this information is also referred to as “pinch-in information.”

File identifying information included in the pinch-in information can include a file name thereof, for example. In addition to the file identifying information, the pinch-in information may include user information, login information and the like associated with portable terminal 300, for example, as information that identifies the user having performed the pinch-in gesture, or may include specific information of portable terminal 300.

Upon receipt of this information, server 500 stores the information in a predetermined area of a memory 55 in Step S21.

When a pinch-out gesture is performed with the function list screen (FIG. 5) being displayed on operation panel 15 of MFP 100 (Step S31), the indicated operation is identified in MFP 100 in Step S32. In response to this pinch-out gesture, MFP 100 inquires of server 500 about the indicated file in Step S33. Here, information that identifies the user having performed the pinch-out gesture and/or information that identifies portable terminal 300 on which a pinch-in gesture has been performed previously may be transmitted in combination with this inquiry. Login information at the time when a pinch-out gesture is performed, for example, corresponds to the above-described user information.

Upon receipt of this inquiry, server 500 identifies a target file referring to the pinch-in information stored in Step S21 described above, and transmits information about that file as file information in Step S22. The file information is information by which a determination can be made in MFP 100 as to whether or not the indicated operation is suitable for that file, and includes, for example, “file type”, “file name”, “date of storage”, and the like.

It is noted that, at this time, authentication may be performed in server 500 using the user information or the like transmitted in combination with the above-described inquiry and the user information or the like included in the pinch-in information. Then, when authentication succeeds, file information may be transmitted.

In the case where a plurality of pieces of pinch-in information are stored, a relevant piece of pinch-in information may be extracted using the user information or the like transmitted in combination with the above-described inquiry.

Upon receipt of the above-described file information, MFP 100 in Step S34 determines whether or not the operation identified in Step S32 described above is suitable as for execution on the indicated file. As a result, when it is determined as a suitable operation, the indicated file is requested from server 500 in Step S35, and in response to that request, the file is transmitted from server 500 to MFP 100 in Step S23.

In MFP 100, in Step S36, the above-described determination result is displayed on operation panel 15. Then, the indicated operation is executed on the file in Step S37.

<Functional Configuration>

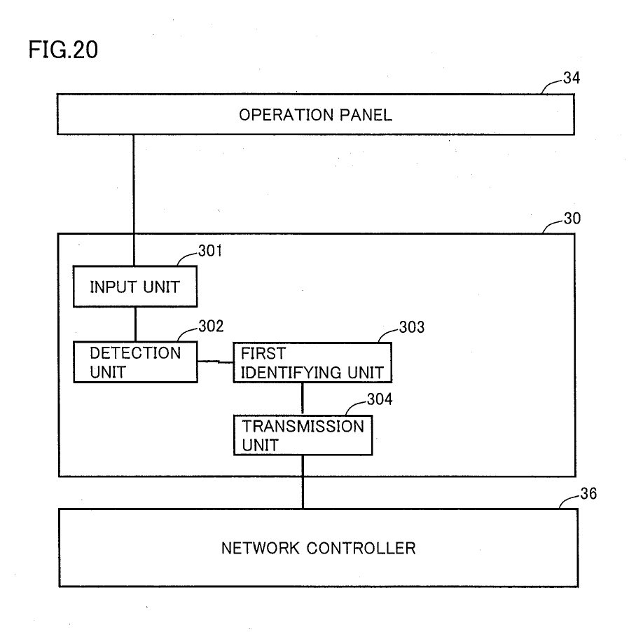

FIGS. 20 to 22 are block diagrams each showing a specific example of a functional configuration of portable terminal 300, server 500 and MFP 100 for executing the above-described operations. These functions are implemented mainly by CPU by each CPU reading a program stored in the ROM and executing it on the RAM. However, at least some functions may be implemented by the hardware configuration shown in the drawings.

It is noted that, as described above, in the image processing system according to the second embodiment, portable terminal 300, server 500 and MFP 100 cooperate to implement the operations in MFP 100 according to the first embodiment. Therefore, the functions of these devices are generally implemented by these devices sharing the functional configuration of MFP 100 according to the first embodiment shown in FIG. 10, with some functions added for communications among these devices.

In more detail, referring to FIG. 20, CPU 30 of portable terminal 300 includes an input unit 301 for receiving input of an operation signal showing an instruction on operation panel 34, a detection unit 302 for detecting the above-described pinch-in gesture based on the operation signal, a first identifying unit 303 for identifying a file presented by an icon indicated by the pinch-in gesture based on an indicated position presented by the operation signal, and a transmission unit 304 for transmitting pinch-in information including information presenting the identified file, to server 500 through network controller 36.

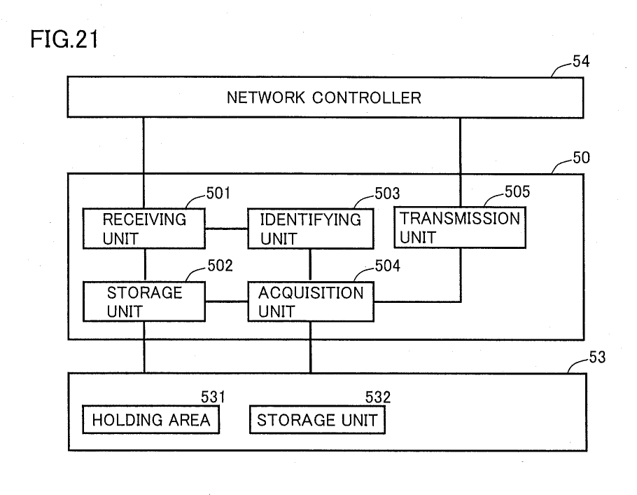

Referring to FIG. 21, HDD 53 of server 500 includes a holding area 531 which is an area for holding pinch-in information transmitted from portable terminal 300 and a storage unit 532 which is a storage area for storing a file.

Further referring to FIG. 21, CPU 50 of server 500 includes a receiving unit 501 for receiving information transmitted from portable terminal 300 and/or MFP 100 through network controller 54, a storage unit 502 for storing pinch-in information transmitted from portable terminal 300 in holding area 531 described above, an identifying unit 503 for receiving the inquiry in Step S33 described above from MFP 100 and identifying file infoiniation, such as the file name of the indicated file, an acquisition unit 504 for receiving the file request from MFP 100 in Step S35 described above and acquiring the indicated file from storage unit 532, and a transmission unit 505 for transmitting information to portable terminal 300 and/or MFP 100 through network controller 54.

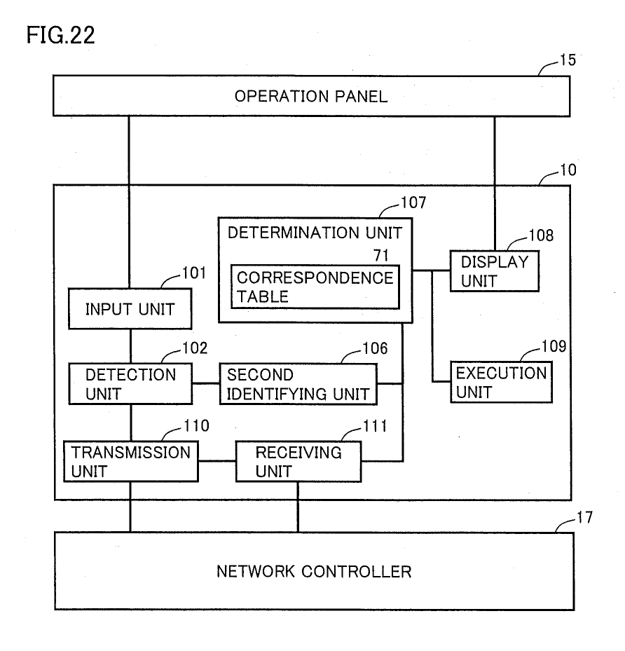

Referring to FIG. 22, CPU 10 of MFP 100 includes input unit 101 for receiving input of an operation signal showing an instruction on operation panel 15, detection unit 102 for detecting the above-described pinch-out gesture based on the operation signal, second identifying unit 106 for identifying an operation presented by an icon indicated by the pinch-out gesture based on an indicated position presented by the operation signal, a transmission unit 110 for transmitting an inquiry and/or a file request to server 500 through network controller 17 in response to the pinch-out gesture, a receiving unit 111 for receiving the file information in Step S22 described above and/or the indicated file in Step S23 described above from server 500 in response to the inquiry and/or request, determination unit 107 for determining whether or not the operation is an operation that can process the indicated file, display unit 108 for making a display on operation panel 15 in accordance with the determination, and execution unit 109 for executing the identified operation on the indicated file when it is a processable operation.

<Flow of Operation>

MFP 100 according to the second embodiment performs an operation generally similar to that in MFP 100 according to the first embodiment shown in FIG. 16. In MFP 100 according to the second embodiment, however, instead of file identification based on the pinch-in gesture on its operation panel 15 in Steps S101 and S103 described above, the operation in Step S33 described above of inquiring pinch-in information in accordance with a pinch-in gesture in portable terminal 300 stored in server 500 with a timing that an operation is identified by a pinch-out gesture is performed.

In MFP 100 according to the second embodiment, similarly to MFP 100 according to the first embodiment, when it is detected that a pinch-out gesture has been started with the function list screen being displayed on operation panel 15, CPU 10 makes the above-described inquiry to acquire file information and identifies an icon targeted for the pinch-out gesture based on the contacts at the time of start of the pinch-out gesture and the contacts at the time of determination to thereby identify an indicated operation, and determines whether or not the operation is suitable for the indicated file (Step S34 described above). Then, the result is displayed along with the pinch-out gesture, and when termination of the pinch-out gesture is detected, a file is requested from server 500 if the identified operation is suitable for the indicated file in that state (Step S35 described above).

It is noted that, with this operation, the display as shown in FIG. 8 or 9 is also displayed.

<Effects of Second Embodiment>

With such an operation performed in the image processing system according to the second embodiment, it is possible to prevent an operation not intended by a user from being executed even when a target file and an operation to be executed are indicated in different devices, respectively.

<Variation 1>

In the above-described first and second embodiments, a plurality of files can also be indicated by performing a plurality of pinch-in gestures.

MFP 100 according to the first embodiment repeats Steps S101 and S103 described above to identify a file to be processed in each pinch-in gesture, and temporarily holds the file in holding area 162 of memory 16.

Portable terminal 300 according to the second embodiment identifies a file to be processed in each pinch-in gesture, and transmits the file to server 500 as pinch-in information. These plurality of pieces of pinch-in information are stored in server 500.

At this time, when a pinch-out gesture is detected in MFP 100, files identified by these plurality of pinch-in gestures are used as files to be processed. That is, in MFP 100, it is determined whether or not the identified operation is suitable for execution on all of these files, and the result is displayed.

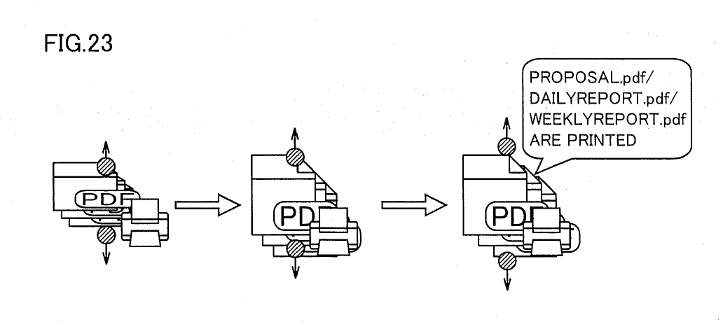

FIG. 23 shows a specific example of a screen display at this time. Referring to FIG. 23, as an example, in this case, information presenting the plurality of files determined to be processed may be displayed in proximity to an icon of the identified operation along with the pinch-out gesture. In the example of FIG. 23, a plurality of icons (a plurality of PDF icons in the example of FIG. 23) presenting a plurality of files indicated by the preceding pinch-in gesture are displayed between the two contacts in association with the pinch-out gesture for indicating the “print icon.” Further, as shown in FIG. 23, identification information such as the respective file names and that they are targeted for printing may be displayed.

In this way, user operability can be improved.

<Variation 2>

As described above, since MFP 100 has stored therein correspondence table 71 that defines information to be a target for each operation, CPU 10 can identify an operation executable on a file referring to correspondence table 71 at the time when the file to be processed is identified.

At this time, if the file is indicated by a pinch-in gesture, for example, an operation suitable for that file may be displayed in proximity to an icon presenting that file.

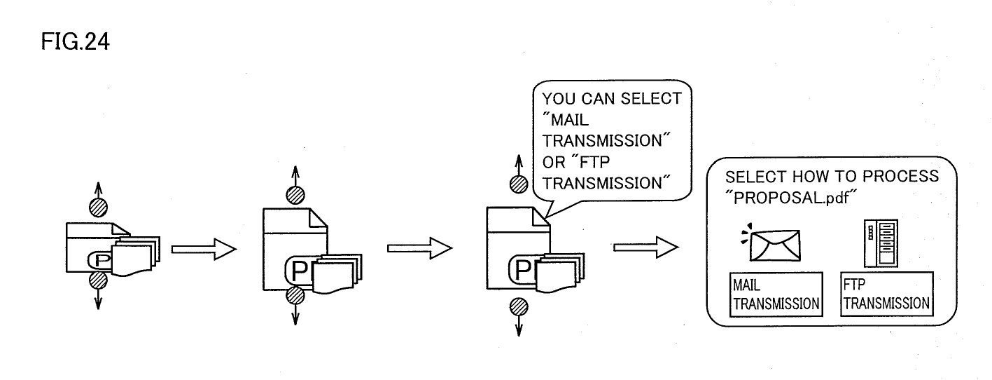

Further, if a plurality of operations are identified at that time, these plurality of operations may be displayed such that a selection can be made, as shown in FIG. 24. CPU 10 receives a selection of operation on the display screen shown in FIG. 24, thereby executing the selected operation on the indicated file.

In this way, user operability can also be improved.

Further, a program for causing the above-described operations to be executed can also be offered to MFP 100. Such a program can be recorded on a computer-readable recording medium, such as a flexible disk attached to a computer, a CD-ROM (Compact Disk-Read Only Memory), a ROM, a RAM, a memory card, or the like, and can be offered as a program product. Alternatively, the program can be offered as recorded on a recording medium such as a hard disk built in a computer. Still alternatively, the program can also be offered by downloading through a network.

It is noted that the program according to the present invention may cause the process to be executed by invoking a necessary module among program modules offered as part of an operating system (OS) of a computer with a predetermined timing in a predetermined sequence. In that case, the program itself does not include the above-described module, but the process is executed in cooperation with the OS. Such a program not including a module may also be covered by the program according to the present invention.

Moreover, the program according to the present invention may be offered as incorporated into part of another program. Also in such a case, the program itself does not include the module included in the above-described other program, and the process is executed in cooperation with the other program. Such a program incorporated into another program may also be covered by the program according to the present invention.

An offered program product is installed in a program storage unit, such as a hard disk, and is executed. It is noted that the program product includes a program itself and a recording medium on which the program is recorded.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An image processing apparatus comprising:
a touch panel;
a display device; and
a processing unit for performing processing based on a contact on said touch panel, wherein
said processing unit includes
a first identifying unit for detecting a first gesture using said touch panel, thereby identifying a file to be processed based on a contact in said first gesture,
a second identifying unit for detecting a second gesture using said touch panel, thereby identifying an operation to be executed based on a contact in said second gesture,
a determination unit for determining whether or not the combination of said file to be processed and said identified operation is appropriate,
a display unit for displaying a determination result in said determination unit, on said display device, and
an execution unit for executing said identified operation on said file to be processed, and
in the case where one of said first identifying unit and said second identifying unit previously detects one of said first gesture and said second gesture to identify one of said file and said operation, and when the other gesture is detected next, then said determination result is displayed on said display device before identification of one of said file and said operation is completed by detection of said other gesture.

2. The image processing apparatus according to claim 1, wherein
said first identifying unit and said second identifying unit decide one of said file and said operation based on said contact at the time of completion of one of said first gesture and said second gesture, and
said execution unit does not execute said identified operation on said file to be processed when it is determined in said determination unit that said combination of said file to be processed and said identified operation as decided is not appropriate, and executes said identified operation on said file to be processed when it is determined that said combination as decided is appropriate.

3. The image processing apparatus according to claim 1, wherein said determination unit has previously stored therein information about a target of each operation executable in said image processing apparatus.

4. The image processing apparatus according to claim 1, wherein
said other gesture is said second gesture,
said second identifying unit identifies said operation at least based on the contact at the time of start of said second gesture when the start of said second gesture is detected, and identifies said operation at least based on the contact at the time of start of said second gesture and the contact at the time of completion of said second gesture when said completion is detected, and
for said file to be processed identified by said first identifying unit, said determination unit determines whether or not each of said operation identified by said second identifying unit at least based on the contact at the time of start of said second gesture and said operation identified by said second identifying unit at least based on the contact at the time of start of said second gesture and the contact at the time of said completion is appropriate.

5. The image processing apparatus according to claim 1, wherein
said other gesture is said first gesture,
said first identifying unit identifies said file to be processed at least based on the contact at the time of start of said first gesture when the start of said first gesture is detected, and identifies said file to be processed at least based on the contact at the time of start of said first gesture and the contact at the time of completion of said first gesture when said completion is detected, and
said determination unit determines whether or not said operation identified by said second identifying unit is appropriate for each of said file to be processed identified by said first identifying unit at least based on the contact at the time of start of said first gesture and said file to be processed identified by said first identifying unit at least based on the contact at the time of start of said first gesture and the contact at the time of said completion.

6. The image processing apparatus according to claim 1, further comprising:
a communications unit for communicating with an other device; and
an acquisition unit for acquiring information that identifies one of a file to be processed and an operation identified in said other device by a gesture using a touch panel of said other device, in place of one of said first identifying unit and said second identifying unit.

7. The image processing apparatus according to claim 1, wherein said first gesture is a gesture of, continuously after two contacts are made on said touch panel, moving said two contacts in a direction that a spacing therebetween is decreased and then releasing said two contacts after being moved, and said second gesture is a gesture of, continuously after two contacts are made on said touch panel, moving said two contacts in a direction that the spacing therebetween is increased and then releasing said two contacts after being moved.

8. A method of controlling an image processing apparatus for causing said image processing apparatus having a touch panel to execute an operation on a file, the method comprising the steps of:
detecting a first gesture using said touch panel, thereby identifying a file to be processed based on a contact in said first gesture;
detecting a second gesture using said touch panel, thereby identifying an operation to be executed based on a contact in said second gesture;
determining whether or not the combination of said file to be processed and said identified operation is appropriate;
displaying a determination result of said determining step on a display device; and
executing said identified operation on said file to be processed when it is determined that the combination of said file to be processed and said identified operation is appropriate, wherein
in the case where one of said step of identifying a file and said step of identifying an operation previously detects one of said first gesture and said second gesture to identify one of said file and said operation, and when the other gesture is detected next, then said determination result is displayed on said display device before identification of one of said file and said operation is completed by detection of said other gesture.

9. The method of controlling according to claim 8, wherein
in said step of identifying a file and said step of identifying an operation, one of said file and said operation is decided based on said contact at the time of completion of one of said first gesture and said second gesture, and
in said step of executing said identified operation on said file to be processed, said identified operation is not executed on said file to be processed when it is determined that the combination of said file to be processed and said identified operation is not appropriate, and said identified operation is executed on said file to be processed when said combination as decided is appropriate.

10. The method of controlling according to claim 8, wherein said image processing apparatus has previously stored therein information about a target of each operation executable in said image processing apparatus, said information being used in said step of determining.

11. The method of controlling according to claim 8, wherein
said other gesture is said second gesture,
in said step of identifying an operation to be executed, said operation is identified at least based on the contact at the time of start of said second gesture when the start of said second gesture is detected, and said operation is identified at least based on the contact at the time of start of said second gesture and the contact at the time of completion of said second gesture when said completion is detected, and
in said step of determining, for said file to be processed identified in said step of identifying a file to be processed, it is determined whether or not each of said operation identified by said step of identifying an operation to be executed at least based on the contact at the time of start of said second gesture and said operation identified in said step of identifying an operation to be executed at least based on the contact at the time of start of said second gesture and the contact at the time of said completion is appropriate.

12. The method of controlling according to claim 8, wherein
said other gesture is said first gesture,
in said step of identifying a file to be processed, said file to be processed is identified at least based on the contact at the time of start of said first gesture when the start of said first gesture is detected, and said file to be processed is identified at least based on the contact at the time of start of said first gesture and the contact at the time of completion of said first gesture when said completion is detected, and
in said step of determining, it is determined whether or not said operation identified in said step of identifying an operation to be executed is appropriate for each of said file to be processed identified in said step of identifying a file to be processed at least based on the contact at the time of start of said first gesture and said file to be processed identified in said step of identifying a file to be processed at least based on the contact at the time of start of said first gesture and the contact at the time of said completion.

13. The method of controlling according to claim 8, further comprising the step of acquiring information that identifies one of a file to be processed and an operation identified in an other device by a gesture using a touch panel of said other device, in place of one of said step of identifying a file to be processed and said step of identifying an operation to be executed.

14. The method of controlling according to claim 8, wherein said first gesture is a gesture of, continuously after two contacts are made on said touch panel, moving said two contacts in a direction that a spacing therebetween is decreased and then releasing said two contacts after being moved, and said second gesture is a gesture of, continuously after two contacts are made on said touch panel, moving said two contacts in a direction that the spacing therebetween is increased and then releasing said two contacts after being moved.

15. A non-transitory computer-readable storage medium having stored therein a program for causing an image processing apparatus having a touch panel and a controller connected to said touch panel to execute an operation on a file, wherein
said program instructs said controller to perform the steps of:
detecting a first gesture using said touch panel, thereby identifying a file to be processed based on a contact in said first gesture;
detecting a second gesture using said touch panel, thereby identifying an operation to be executed based on a contact in said second gesture;
determining whether or not the combination of said file to be processed and said identified operation is appropriate;
displaying a determination result of said determining step on a display device; and
executing said identified operation on said file to be processed when it is determined that the combination of said file to be processed and said identified operation is appropriate, and
in the case where one of said step of identifying a file and said step of identifying an operation previously detects one of said first gesture and said second gesture to identify one of said file and said operation, and when the other gesture is detected next, then said program causes said determination result to be displayed on said display device before identification of one of said file and said operation is completed by detection of said other gesture.

16. The non-transitory computer-readable storage medium according to claim 15, wherein
in said step of identifying a file and said step of identifying an operation, said controller decides one of said file and said operation based on said contact at the time of completion of one of said first gesture and said second gesture, and
in said step of executing said identified operation on said file to be processed, said controller does not execute said identified operation on said file to be processed when said determination result is that the combination of said file to be processed and said identified operation as decided is not appropriate, and executes said identified operation on said file to be processed when said combination as decided is appropriate.

17. The non-transitory computer-readable storage medium according to claim 15, wherein said image processing apparatus includes a memory for storing information about a target of each operation executable in said image processing apparatus, said information being used in said step of determining.

18. The non-transitory computer-readable storage medium according to claim 15, wherein
said other gesture is said second gesture, and
in said step of identifying an operation to be executed, said controller identifies said operation at least based on the contact at the time of start of said second gesture when the start of said second gesture is detected, and identifies said operation at least based on the contact at the time of start of said second gesture and the contact at the time of completion of said second gesture when said completion is detected, and
in said step of determining, for said file to be processed identified in said step of identifying a file to be processed, said controller determines whether or not each of said operation identified by said step of identifying an operation to be executed at least based on the contact at the time of start of said second gesture and said operation identified in said step of identifying an operation to be executed at least based on the contact at the time of start of said second gesture and the contact at the time of said completion is appropriate.

19. The non-transitory computer-readable storage medium according to claim 15, wherein
said other gesture is said first gesture,
in said step of identifying a file to be processed, said controller identifies said file to be processed at least based on the contact at the time of start of said first gesture when the start of said first gesture is detected, and identifies said file to be processed at least based on the contact at the time of start of said first gesture and the contact at the time of completion of said first gesture when said completion is detected, and
in said step of determining, said controller determines whether or not said operation identified in said step of identifying an operation to be executed is appropriate for each of said file to be processed identified in said step of identifying a file to be processed at least based on the contact at the time of start of said first gesture and said file to be processed identified in said step of identifying a file to be processed at least based on the contact at the time of start of said first gesture and the contact at the time of said completion.

20. The non-transitory computer-readable storage medium according to claim 15, wherein said program instructs said controller to perform the step of acquiring information that identifies one of a file to be processed and an operation identified in an other device by a gesture using a touch panel of said other device, in place of one of said step of identifying a file to be processed and said step of identifying an operation to be executed.

21. The non-transitory computer-readable storage medium according to claim 15, wherein said first gesture is a gesture of, continuously after two contacts are made on said touch panel, moving said two contacts in a direction that a spacing therebetween is decreased and then releasing said two contacts after being moved, and said second gesture is a gesture of, continuously after two contacts are made on said touch panel, moving said two contacts in a direction that the spacing therebetween is increased and then releasing said two contacts after being moved.
